(19) United States
(12) Patent Application Publication
(10) Pub. No.: US 2004/0025093 A1
(43) Pub. Date: Feb. 5, 2004

(54) System and method for collecting code coverage information on fatal error path code

(76) Inventors: Jeff Willy, Plano, TX (US); Mark Hattarki, Fort Worth, TX (US); Dave Maison, Richardson, TX (US); Jorge Gonzalez, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/209,781

(22) Filed: Jul. 31, 2002

(51) Int. Cl. H02H 3/05; G06F 15/177

(52) U.S. Cl. 714/54; 713/2

(57) ABSTRACT

A system and method for collecting code coverage information relating to a fatal error path in a computer system. A fatal error operable to crash the computer system is instigated pursuant to executing a fatal error test module that exercises the fatal error path code, whose coverage is desired after the file system is rendered unavailable due to the crash. In response, a first dump file is created by the operating system kernel. Thereafter, a second dump process is launched to generate a second dump file which includes coverage information relating to the fatal error path code. After rebooting the computer system, an extractor is utilized to recover the code coverage information from the second dump file.

### CROSS-REFERENCE TO RELATED APPLICATION(S)

This application discloses subject matter related to the subject matter disclosed in the following commonly owned co-pending patent application(s): (i) “System And Method For Collecting Code Coverage Information Before File System Is Available,” filed even date herewith, application Ser. No.: ______ (Docket Number 10018529-1), in the name(s) of: Jorge Gonzalez, Mark Nathan Hattarki, Jeff Willy and David Leon Maison; and (ii) “System And Method For Testing Fatal Error Handling And Recovery Code Functionality In A Computer System,” filed Nov. 16, 2001, application Ser. No.: 09/991,318, in the name(s) of: Mark Nathan Hattarki and David Leon Maison.

### BACKGROUND OF THE INVENTION

1. Technical Field of the Invention

The present invention generally relates to computer systems. More particularly, and not by way of any limitation, the present invention is directed to a system and method for collecting code coverage information on fatal error path code portion of an operating system.

2. Description of Related Art

Code coverage analysis includes various structural and functional testing techniques which can be used to determine where additional testing is required with respect to a code portion. Structural testing technique (also sometimes referred to as “glass box” testing or “white box” testing) is used to uncover untested areas of code. Structural testing compares test program behavior against the apparent intention of the source code. This is in contrast to functional testing (referred to as “black box testing”), which compares test program behavior against a requirements specification. Structural testing is also called path testing since one can choose test cases that cause alternative paths to be taken through the structure of the program. Whereas structural testing examines how the program works, taking into account possible pitfalls in the structure and logic of the code, functional testing evaluates what the program accomplishes, without regard to how it works internally.

As a software testing technique, code coverage analysis is a powerful tool for exploring different parts of a lengthy computer program having extensive and complex internal structure such as, for example, an operating system (OS) kernel, to ensure that various modules of the program are structurally well-integrated. Not only is the coverage data useful in developing and evaluating defect-free software, but it can also be employed in verifying that a program's critical areas are adequately covered by the tests designed to exercise it. Relatedly, code coverage analysis is helpful in ascertaining that a minimum percentage of coverage of a program is met.

An important component of any OS is the functionality that is responsible for handling fatal errors in a computer system. Typically, when the computer system encounters a fatal error, i.e., an error where processing cannot continue and the OS must abort, it is provided with the capability to write, if possible, what is known as a “core dump” (or “dump”, for short) to a local disk before attempting to exit gracefully (i.e., before the system crashes) . One or more dump files which provide a snapshot of the state of system memory, partial or otherwise, are accordingly created in the process.

Usually, the fatal errors are caused in the operation of the OS itself (e.g., due to a violation of certain critical conditions), or due to unrecoverable hardware failures, or because of a combination thereof. Further, crashes due to fatal errors may occur during the OS boot-up process, after the OS is up and running, or during the execution of an application. In some instances, a system may also crash during a power down sequence. Regardless of how or when a system crashes, the dump files are generally useful, when created, in diagnosing the error or errors that caused it.

It is well known that the usefulness of a core dump file is dependent, in large part, on a number of factors, however. The dump file created during the core dump process must be a valid file if its contents were to be helpful in properly diagnosing, upon rebooting the system, the problem that caused the fatal error. That is, it must be ensured that when a system crashes the crash and dump paths of the OS are robustly structured and execute valid processes and, moreover, the processes must yield expected dump files for particular known fatal errors. In addition, it must also be ensured that the dump files contain enough relevant information to be useful for diagnosis.

There exist several testing methodologies operating to verify the integrity of a computer system's fatal error handling and recovery code functionality by examining the core dump files upon rebooting. Whereas it is elementary that the OS code responsible for handling fatal errors (i.e., fatal error path code) should be vigorously tested, preferably by both black box testing and white box testing techniques, obtaining coverage information regarding the relevant code portion has proved to be rather difficult. In general, collecting code coverage information requires two conditions. First, it has been necessary that a file system be available for populating what are known as code coverage buffers with the appropriate coverage data. Second, a special utility tool is typically required to transfer the coverage information from memory to a file on disk. Unfortunately, when a computer system panics (i.e., encounters a fatal error), the fatal error path code gets kicked in and neither of the these requirements can be met. Rather, the system attempts to shut down as gracefully as possible (i.e., the file system becomes unavailable) and then tries to reboot. Upon rebooting, however, whatever code coverage data that has been collected is lost or rendered unusable.

### SUMMARY OF THE INVENTION

Accordingly, the present invention advantageously provides a system and method for collecting code coverage information relating to a fatal error path code potion in a computer system. A fatal error operable to crash the computer system is instigated pursuant to executing a fatal error test module that exercises the OS kernel's fatal error path code whose coverage is desired after the file system is rendered unavailable due to the crash. In response to the fatal error, a first dump file is created by the OS kernel. Thereafter, a second dump process is launched by the OS kernel to generate a second dump file which includes code coverage information relating to the fatal error path code as exercised by the test module. After rebooting the computer system, an extractor is utilized to recover the code coverage information from the second dump file.

### BRIEF DESCRIPTION OF THE DRAWINGS

A more complete understanding of the present invention may be had by reference to the following Detailed Description when taken in conjunction with the accompanying drawings wherein:

FIG. 1 (Prior Art) depicts a flow chart of the steps involved in an exemplary conventional methodology pursuant to executing a fatal error test module;

FIG. 2 depicts a flow chart of the steps involved in the methodology for collecting code coverage information relating to the fatal error path code of an OS kernel in accordance with the teachings of the present invention; and

FIG. 3 a high level functional block diagram of an exemplary system of the present invention for collecting code coverage information relating to the fatal error testing process.

### DETAILED DESCRIPTION OF THE DRAWINGS

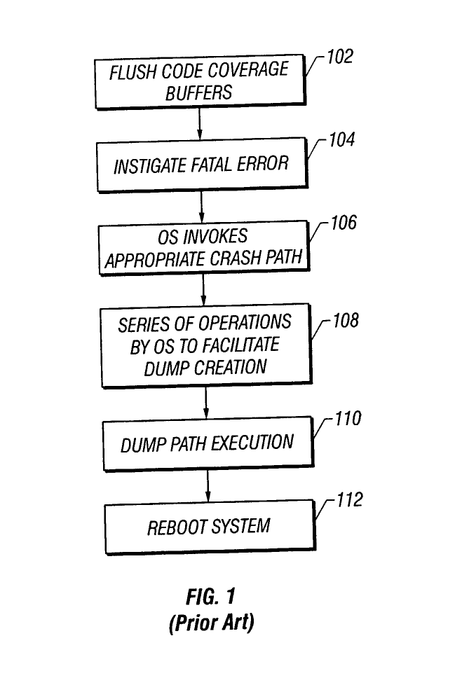

In the drawings, like or similar elements are designated with identical reference numerals throughout the several views thereof, and the various elements depicted are not necessarily drawn to scale. Referring now to FIG. 1, depicted therein is a flow chart of the steps involved in an exemplary conventional methodology pursuant to executing a fatal error test module that is operable to exercise the various parts of an OS kernel's fatal error path code portion. Typically, prior to the launching of the fatal error test module for testing and verifying the integrity of a fatal error handling process in a computer system, the code coverage (CC) buffers of the system are flushed (i.e., zeroed out) so that only the relevant coverage data may be written to the buffers during the fatal error path code execution (step 102). For purposes of the present patent application, fatal error path code may be defined as the collection of routines and functions within the kernel that handles a fatal error, usually resulting in the system reboot. Crash path code is a part of the fatal error path code that is responsible for saving the context of the fatal error and preparing the system for the reboot. This code calls a dump path code portion of the fatal error path code that performs the dumping of main memory (physical memory) to secondary memory (e.g., a disk). Further, error path code is a generic term indicating any code whose purpose is to handle errors. Since not all errors are fatal, the fatal error path code of a kernel would be a subset of its error path code in a general sense.

As part of executing the fatal error path code testing module, a fatal error is instigated (104), which may involve a software error (e.g., involving the OS), a hardware error, or a combination thereof, and may occur in any state of the computer system (i.e., fully loaded state, partially loaded state, and the like). In response, the OS invokes a system-specific crash path (step 106) which is preferably comprised of the OS kernel code (i.e., crash path code) responsible for resetting the system pursuant to an unrecoverable catastrophic event. Thereafter, a series of operations are taken by the OS to facilitate the creation of a dump file, preferably on a local disk (step 108), using a system-specific dump path. As pointed out above, the dump path is generally comprised of the OS kernel code responsible for saving the computer system's physical memory for post-execution debugging. Upon executing the suitable dump path, the dump file is created and the system gracefully shuts down (step 110). The computer system may then be rebooted and the contents of the dump file may be examined (step 112) as part of verifying the error handling process.

Whereas the conventional methodology set forth above may be sufficient for testing the fatal error handling process of the system, adequate code coverage information relating to the fatal error path code cannot be gathered, however. As pointed out in the Background section of the present patent application, collecting code coverage information typically requires that (i) the file system of the computer be available; and (ii) a software utility tool be executed to transfer the coverage information from memory to a file on disk. It will be recognized that neither of these conditions can be met when the machine experiences a fatal error pursuant to executing a particular fatal error module. First, when the crash path code is invoked, the file system is shut down, so no file-system-based writing is possible afterwards. Although the CC buffers continue to get updated during the steps 106 and 108, the execution of dump path code in step 110 will result in only partial CC buffer updating (i.e., incomplete coverage), however, as there is a race condition between the dumping process and the CC buffer updating process. Thus, adequate code coverage information relating to the execution of the entire fatal error path code cannot be obtained, which is a significant disadvantage because the quality of such error path code or the test modules that exercise it cannot be assured.

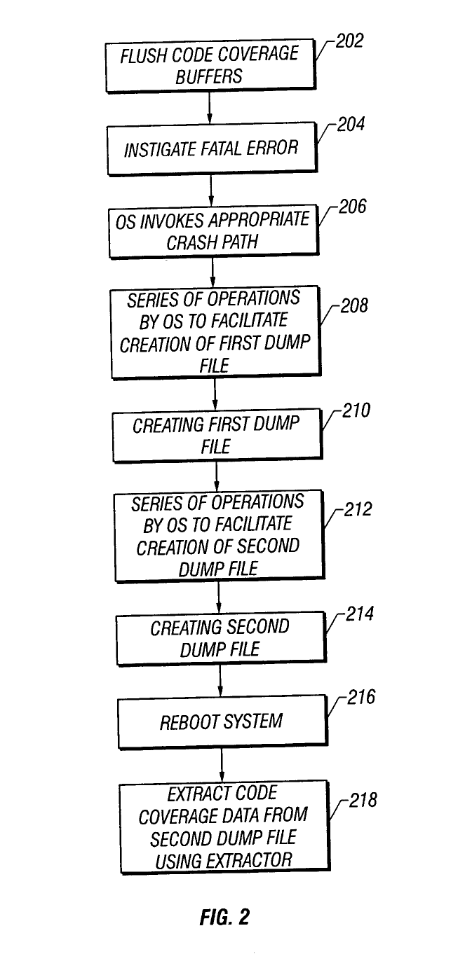

FIG. 2 depicts a flow chart of the steps involved in the exemplary methodology for collecting code coverage information relating to the execution of fatal error path code in accordance with the teachings of the present invention. As is the case with the conventional methodology set forth hereinabove, the code coverage buffers of the system may be flushed prior to the launching of a suitable fatal error test module (step 202) so that only relevant data populates the coverage buffers. A fatal error is then instigated pursuant to exercising the fatal error path code of the system (step 204). Responsive thereto, the OS invokes appropriate crash path code (step 206) to gracefully shut down the system. A series of operations are taken by the OS by way of executing the dump path code of the present invention. Preferably, the dump path code is modified such that the entire dump process before the shutdown is executed as a tandem process of two separate dump operations wherein the race condition between dumping and CC buffer updating is avoided. Accordingly, a first dump file is created in a first dump process that is initiated by the OS kernel as a normal response to the fatal error experienced by the system (steps 208 and 210). The CC buffers thus continue to get updated with complete execution of the dump path code in the first dump. Thereafter, a series of operations are taken at the end of the modified dump path code of the OS kernel to launch a second dump process, wherein a second dump file involving the complete code coverage data (updated during the first dump process) is created responsive thereto (steps 212 and 214). In other words, the total coverage of the dump path code is captured in the second dump because the system has been recording, in the CC buffers, code coverage data all through the first dump. Thus, although the second dump process typically destroys the contents of the first dump file, it should be realized that complete code coverage data still present in the memory is dumped in the second dump process. As a result, the second dump file contains a copy of the code coverage data present in the memory just before it is written to a disk, along with any remaining parts of the memory image.

Preferably, the dump path code is operable such that the second dump file having the complete code coverage data is copied to a “raw” dump device that does not need a file system. In one embodiment, the raw dump device can be a local disk drive that is specified by a device-specific hardware configuration path internal to the OS kernel. In other embodiments, the raw device can be any storage medium internally configurable by the OS via a hardware path during a dump process, provided the device is capable of persistent storage and has a fast transfer rate.

Continuing to refer to FIG. 2, the second dump file created on the raw device includes the CC data (step 214), which dump file is operable to be copied into a file that exists under a file system created pursuant to a subsequent boot up operation. Accordingly, the functionality of the raw storage device relates to storing a specified memory image (including the CC data) before the memory image is scrubbed through power cycling. Thereafter, upon rebooting the machine (step 216), the code coverage data can be extracted from the contents of the second dump file using a debugging tool, which coverage data may be analyzed with a view to quantifying untested areas of code, if any (step 218).

In another embodiment of the present invention, it will be recognized that the teachings set forth above may be implemented as a computer program product operable to collect code coverage information relating to a fatal error path in a computer system. The computer program product may preferably be embodied as a computer usable medium having computer readable program code thereon. OS kernel code is provided for creating an operating system (OS) instance executable on a processor domain associated with the computer system. Associated therewith is program code operable to instigate a fatal error in the computer system, wherein the fatal error operates to crash the computer system pursuant to executing a fatal error test module whose coverage of the kernel's fatal error path code is desired. Also included therewith is program code operable to create a first dump file in a first dump process initiated, responsive to the fatal error, by the OS instance. Additional program code is also included which is operable to create a second dump file by the OS instance in response to a second dump process. The second dump file, preferably operable to eliminate the first dump file, includes code coverage information relating to the kernel's fatal error path code. Extractor code is provided for extracting the code coverage information from the second dump file upon rebooting the computer system.

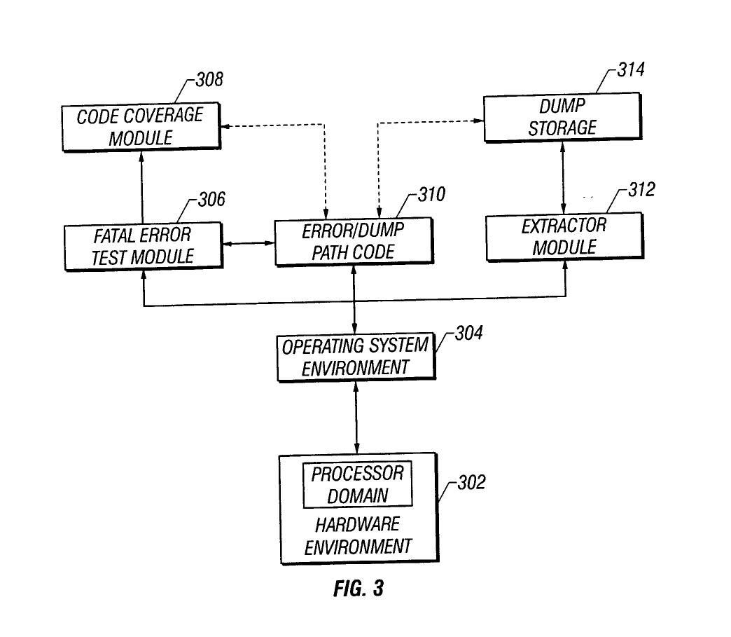

Referring now to FIG. 3, shown therein is a high level functional block diagram of an exemplary system of the present invention for collecting code coverage information relating to the fatal error testing process after the system has crashed. Reference numeral 302 refers to the hardware environment of the computer system wherein the teachings of the present invention may be advantageously practiced. In one embodiment of the present invention, the hardware of the computer system may be organized as a multicellular platform in a symmetrical multiprocessing (SMP) environment that supports the grouping of processor cells into one or more processor domains. A suitable OS environment 304 is operable to run on the hardware. A fatal error test module 306, whose coverage of the OS kernel's fatal error path code portion is desired, operates in association with a code coverage module 308 for collecting the various types of coverage information during the execution of the test module. Also, an error/dump path code portion 310 (collectively, the kernel's fatal error path code) that is modified as set forth above is provided as program code operable to be executed in association with, or as part of, the OS kernel, for generating a second dump file on a hardware-path-specific raw dump storage 314. An extractor module 312 may be provided as separate program code (e.g., embodied as a computer program product) that can work in conjunction with commercially available coverage programs such as, e.g., C-Cover. As has been explained hereinabove, the extractor module 312 is operable to extract the necessary coverage information relating to the fatal error path code from the secondary dump storage 314 created in accordance with the modified core dump process.

Preferably, the code coverage module 308 is operable to support various types of code coverage information relating to the selected fatal error path code. Some of the exemplary coverage measures and their brief description are set forth immediately below:

Statement Coverage: Also known as line coverage, segment coverage, or basic block coverage, this measure reports whether each executable statement in the error path code is encountered.

Decision Coverage: This measure reports whether Boolean expressions tested in control structures (such as IF statement, WHILE statement, et cetera) evaluated to both TRUE and FALSE. The decision coverage measure is also referred to as branch coverage, all-edges coverage, or basis path coverage.

Condition Coverage: This measure reports the TRUE or FALSE outcome of each Boolean sub-expression, separated by LOGICAL-AND and LOGICAL-OR if they occur.

Path Coverage: This measure reports whether each of the possible paths in each function have been followed. Also known as predicate coverage, this measure views paths as possible combinations of logical conditions, wherein a path is defined to be a unique sequence of branches from the function entry to its exit/return.

Function Coverage: This measure tracks whether each function or procedure of the error path code is invoked during the execution of the test module.

Several other coverage measures such as call coverage, linear code sequence and jump (LCSAJ) coverage, data flow coverage, object code branch coverage, loop coverage, race coverage, weak mutation coverage, table coverage, etc. can also be included as part of the code coverage information gathered in accordance with the teachings of the present invention.

Various test modules may be employed for testing the fatal error handling and recovery code functionality of the computer system, and it may be desirable to obtain the error path's coverage information relating to each of the test modules. Thus, the test modules comprising one or more test scenarios, including different test types, dump parameters (e.g., full dumps, partial dumps, load conditions, and the like), performance criteria (disk space consumption, time taken for dumps, and the like), etc., may be set up for testing one or more aspects of the computer system's fatal error handling process. It should be appreciated that the test scenarios of the fatal error test module (which may be referred to as a crash dump test harness) can be advantageously customized to verify that the operating system's fatal error handling and recovery code functionality behaves as expected in various hardware and software configurations.

Further, those skilled in the art should recognize that the present invention is operable to provide code coverage information relating to several types of core dump scenarios such as, e.g., full dumps, selective dumps, and partial dumps. A full dump contains a copy of the entire system memory. A selective dump can be specified by selecting particular memory region(s) to copy. Exemplary selection criteria can be unused memory pages, kernel data structures, et cetera, and a selective dump may be done to simply verify that the feature of selecting the contents is operational. Either of these dump scenarios can be modified by further indicating the amount of storage space to be used for the dump files, whereby a partial dump may be effectuated as appropriate. Accordingly, a partial full dump or a partial selective dump may be implemented. Moreover, the various dumps may be caused under different machine conditions (e.g., fully loaded vs. idle conditions). In the context of the present invention, a loaded system is one where many user processes are being run on a fully booted system. In contrast, an idle condition may be defined as the condition where no user processes (or an insignificant number of user processes) are up and running.

Additionally, several types of fatal errors (e.g., hardware errors, OS errors, etc.) can be instigated at various stages of the operation of the computer system, e.g., in a shutdown sequence, with loads of different magnitudes, or during a manual intervention, for causing a preselected test dump scenario. Accordingly, it should be appreciated that the fatal error path's coverage may be obtained under different scenarios in accordance with the teachings of the present invention, e.g., full dump on an idle system, selective dump on a machine with a full load, partial selective dump on an idle machine, partial full dump on a fully loaded system, full dump on a fully loaded system, et cetera. Some of the exemplary fatal error test sequences for which code coverage information can be gathered in accordance with the teachings of the present invention in an HP-UX® environment are provided in the following commonly owned co-pending patent application(s): (i) “System And Method For Testing Fatal Error Handling And Recovery Code Functionality In A Computer System,” filed Nov. 16, 2001, application Ser. No.: 09/991,318, in the name(s) of: Mark Nathan Hattarki and David Leon Maison, which is(are) hereby incorporated by reference.

It should be further appreciated by those skilled in the art upon having reference hereto that the hardware platform 302 may be comprised of any computer including, but not limited to, uniprocessor systems, multiprocessor (MP) systems such as symmetric and asymmetric MP systems, tightly-coupled or loosely-coupled MP systems, multicellular platforms wherein each cell comprises one or more processors, and the like. Similarly, the OS 304 may comprise any known and/or heretofore unknown operating systems such as Unix-based operating systems, e.g., HP-UX®, Solaris®, SunOS®, AIX®, Ultrix®, Windows®-based operating systems, e.g., Windows® 2000, NT®, etc., MacOS®, Open VMS, and the like.

Based upon the foregoing Detailed Description, it should be apparent that the present invention provides an innovative system and method operable in a high performance computing environment for obtaining code coverage information relating to the testing of various fatal error code paths selectable by specifying several testing parameters. Quality of the testing modules can be not only assured but, where necessary, can also be significantly improved, as the untested portions of the error path code can be uncovered and new tests and/or test flows can be developed to fill the coverage gaps. Since the test flows can be customized to suit different software and hardware configurations, coverage information can be reliably gathered in all types of computing environments.

Moreover, the code coverage methodology of the present invention can be used to collect coverage information on other tests as well. For example, if a test crashed the system for some reason, the machine would normally reboot and the all coverage data relating to the test code would be lost. That information would have been valuable, because it would show the portion of code that was exercised by the test and caused the problem. The present invention advantageously preserves such information for subsequent extraction and analysis.

It is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims. For example, while the teachings of the present invention have been generally exemplified within the context of an MP platform running the HP-UX® OS environment, those skilled in the art should recognize that the present invention can be practiced in conjunction with other hardware and software platforms. Also, the fatal errors deliberately caused to create a system crash may comprise OS-based errors, hardware errors, or a combination thereof. Furthermore, the code coverage information in the second dump files may be stored locally or remotely, using any known or heretofore unknown storage medium. Accordingly, all such modifications, extensions, variations, amendments, additions, deletions, combinations, and the like are deemed to be within the ambit of the present invention whose scope is defined solely by the claims set forth hereinbelow.

What is claimed is:

1. A method of collecting code coverage information relating to a fatal error path in a computer system, said computer system executing an operating system (OS) kernel, comprising:
instigating a fatal error in said computer system, said fatal error operating to crash said computer system pursuant to executing a fatal error test module;
in response, creating a first dump file in a first dump process initiated by said kernel;
creating a second dump file by said kernel responsive to a second dump process, said second dump file including code coverage information relating to said fatal error path; and
extracting said code coverage information from said second dump file upon rebooting said computer system.

2. The method of collecting code coverage information as set forth in claim 1, wherein said fatal error comprises a hardware error.

3. The method of collecting code coverage information as set forth in claim 1, wherein said fatal error comprises an OS error.

4. The method of collecting code coverage information as set forth in claim 1, wherein said fatal error test module includes executing a full dump.

5. The method of collecting code coverage information as set forth in claim 1, wherein said fatal error test module includes executing a selective dump.

6. The method of collecting code coverage information as set forth in claim 1, wherein said fatal error test module includes executing a partial dump.

7. The method of collecting code coverage information as set forth in claim 1, wherein said fatal error test module is executed when said computer system is fully loaded.

8. The method of collecting code coverage information as set forth in claim 1, wherein said fatal error test module is executed when said computer system is in an idle condition.

9. The method of collecting code coverage information as set forth in claim 1, wherein said second dump file is created on a local storage medium.

10. The method of collecting code coverage information as set forth in claim 1, wherein said second dump file is created on a storage medium configurable through a device-specific hardware path internal to the OS kernel.

11. The method of collecting code coverage information as set forth in claim 1, wherein said fatal error test module is executed during a shutdown sequence of said computer system.

12. The method of collecting code coverage information as set forth in claim 1, wherein said step of extracting said code coverage information is performed using a debugging tool.

13. A system for collecting code coverage information relating to a fatal error path in a computer system, comprising:
means for instigating a fatal error in said computer system, said fatal error operating to crash said computer system pursuant to executing a fatal error test module;
means for creating, responsive to said fatal error, a first dump file in a first dump process initiated by an operating system (OS) kernel running on said computer system;
means for creating a second dump file by said kernel responsive to a second dump process, said second dump file including code coverage information relating to said fatal error path; and
an extractor operable to extract said code coverage information from said second dump file upon rebooting said computer system.

14. The system for collecting code coverage information as set forth in claim 13, wherein said fatal error comprises a hardware error.

15. The system for collecting code coverage information as set forth in claim 13, wherein said fatal error comprises an OS error.

16. The system for collecting code coverage information as set forth in claim 13, wherein said fatal error test module is operable to execute a full dump.

17. The system for collecting code coverage information as set forth in claim 13, wherein said fatal error test module is operable to execute a selective dump.

18. The system for collecting code coverage information as set forth in claim 13, wherein said fatal error test module is operable to execute a partial dump.

19. The system for collecting code coverage information as set forth in claim 13, wherein said fatal error test module is executed when said computer system is fully loaded.

20. The system for collecting code coverage information as set forth in claim 13, wherein said fatal error test module is executed when said computer system is in an idle condition.

21. The system for collecting code coverage information as set forth in claim 13, wherein said second dump file is created on a local storage medium.

22. The system for collecting code coverage information as set forth in claim 13, wherein said second dump file is created on a storage medium configurable through a device-specific hardware path internal to the OS kernel.

23. The system for collecting code coverage information as set forth in claim 13, wherein said fatal error test module is executed during a shutdown sequence of said computer system.

24. The system for collecting code coverage information as set forth in claim 13, wherein said extractor comprises a debugging tool.

25. A computer program product operable to collect code coverage information relating to a fatal error path in a computer system, said computer program product including a computer usable medium with computer readable program code thereon, comprising:
operating system code for creating an operating system (OS) instance executable on a processor domain associated with said computer system;
program code operable to instigate a fatal error in said computer system, said fatal error operating to crash said computer system pursuant to executing a fatal error test module;
program code operable to create, responsive to said fatal error, a first dump file in a first dump process initiated by said OS instance running on said computer system;
program code operable to create a second dump file by said OS instance responsive to a second dump process, said second dump file including code coverage information relating to said fatal error path; and
program code operable to extract said code coverage information from said second dump file upon rebooting said computer system.

26. The computer program product operable to collect code coverage information as set forth in claim 25, wherein said fatal error comprises a hardware error.

27. The computer program product operable to collect code coverage information as set forth in claim 25, wherein said fatal error comprises an OS error.

28. The computer program product operable to collect code coverage information as set forth in claim 25, wherein said fatal error test module is operable to execute a full dump.

29. The computer program product operable to collect code coverage information as set forth in claim 25, wherein said fatal error test module is operable to execute a selective dump.

30. The computer program product operable to collect code coverage information as set forth in claim 25, wherein said fatal error test module is operable to execute a partial dump.

31. The computer program product operable to collect code coverage information as set forth in claim 25, wherein said fatal error test module is executed when said computer system is fully loaded.

32. The computer program product operable to collect code coverage information as set forth in claim 25, wherein said fatal error test module is executed when said computer system is in an idle condition.

33. The computer program product operable to collect code coverage information as set forth in claim 25, wherein said second dump file is created on a local storage medium.

34. The computer program product operable to collect code coverage information as set forth in claim 25, wherein said second dump file is created on a storage medium configurable through a device-specific hardware path internal to the OS kernel.

35. The computer program product operable to collect code coverage information as set forth in claim 25, wherein said fatal error test module is executed during a shutdown sequence of said computer system.
